(19) United States
(12) Patent Application Publication
(10) Pub. No.: US 2026/0353349 A1
(43) Pub. Date: Nov. 5, 2026

(54) EARTH MOVING CELL ENHANCEMENTS

(71) Applicant: APPLE INC., Cupertino, CA (US)

(72) Inventors: Yuqin Chen, Beijing (CN); Fangli Xu, Beijing (CN); Ralf Rossbach, Munich (DE); Alexander Sirotkin, Hod Hasharon (IL); Peng Cheng, Beijing (CN); Ping-Heng Kuo, London (GB); Zhibin Wu, Los Altos, CA (US); Naveen Kumar R Palle Venkata, San Diego, CA (US); Haijing Hu, Los Gatos, CA (US)

(21) Appl. No.: 18/997,601

(22) PCT Filed: Aug. 8, 2022
(86) PCT No.: PCT/CN2022/110746

§ 371 Date: Jan. 22, 2025

(51) Int. Cl. H04W 64/00; H04W 24/10; H04W 36/36; H04W 84/06

(52) U.S. Cl. CPC H04W 64/006; H04W 24/10; H04W 36/362; H04W 84/06

(57) ABSTRACT

There is provided an apparatus of a user equipment (UE), the apparatus comprising: a processor; and a memory storing instructions that, when executed by the processor, configure the apparatus to: receive a reference location and movement information of a serving cell of the UE which is an earth moving cell; determine a current reference location of the serving cell based on the received reference location and movement information; and decide whether to initiate Radio Resource Management (RRM) measurement on neighbor cells based on the current reference location of the serving cell.

### TECHNICAL FIELD

The present application relates generally to wireless communication systems, including providing enhancements to mobility management of an earth moving cell, for example, in a 5G communication system.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### SUMMARY

In one aspect, there is provided an apparatus of a user equipment (UE), the apparatus comprising: a processor; and a memory storing instructions that, when executed by the processor, configure the apparatus to: receive a reference location and movement information of a serving cell of the UE which is an earth moving cell; determine a current reference location of the serving cell based on the received reference location and movement information; and decide whether to initiate Radio Resource Management (RRM) measurement on neighbor cells based on the current reference location of the serving cell.

In another aspect, there is provided an apparatus of a base station, the apparatus comprising: a processor; and a memory storing instructions that, when executed by the processor, configure the apparatus to: send a reference location and movement information of a serving cell of the UE which is an earth moving cell to a user equipment (UE), for the UE to determine a current reference location of the serving cell and to decide whether to initiate Radio Resource Management (RRM) measurement on neighbor cells based on the current reference location of the serving cell.

In still another aspect, there is provided a method, the method comprising: receiving a reference location and movement information of a serving cell of the UE which is an earth moving cell; determining a current reference location of the serving cell based on the received reference location and movement information; and deciding whether to initiate Radio Resource Management (RRM) measurement on neighbor cells based on the current reference location of the serving cell.

In yet still another aspect, there is provided a method, the method comprising: sending a reference location and movement information of a serving cell of the UE which is an earth moving cell to a user equipment (UE), for the UE to determine a current reference location of the serving cell and to decide whether to initiate Radio Resource Management (RRM) measurement on neighbor cells based on the current reference location of the serving cell.

In yet still another aspect, there is provided a non-transitory computer readable storage medium containing instructions which, when executed, cause performance of any above method.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to some embodiments of the present application.

FIG. 2 illustrates a system for performing signaling between a wireless device and a network device, according to some embodiments of the present application.

FIG. 3 illustrates an example of the NTN architecture in an air-to-ground (ATG) scenario.

FIG. 4 illustrates an example coverage of an NTN cell.

FIG. 5 illustrates coverages of a serving cell provided by a satellite and neighbor cells at three time instances.

FIG. 6 illustrates a swimlane diagram of a process of initiating the RRM measurement according to some embodiments of the present application.

FIG. 7 illustrates an example of decomposition of the serving cell's movement in two dimensions.

FIG. 8 illustrates a table of [time, reference location] list according to some embodiments of the present application.

FIG. 9 illustrates an example of a neighbor cell configuration according to some embodiments of the present application.

FIG. 10 illustrates an example of selecting neighbor cells based on the neighbor cell configuration according to some embodiments of the present application.

FIG. 11 illustrates an example of selecting neighbor cells based on location according to some embodiments of the present application.

FIG. 12 illustrates an example scenario for conditional handover (CHO).

### DETAILED DESCRIPTION

Various illustrative embodiments of the present application will be described hereinafter with reference to the drawings. For purpose of clarity and simplicity, not all features are described in the specification. Note that, however, many settings specific to the implementations can be made in practicing the embodiments of the present application. In addition, it should be noted that in order to avoid obscuring the description, some of the figures illustrate only steps of a process and/or components of a device that are closely related to the technical solutions of the present application, while in some other figures, well-known process steps and/or device structures are shown for only better understanding of the present application.

For convenient explanation, various aspects of the present application will be described below in the context of the 5G NR. However, it should be noted that this is not a limitation on the scope of application of the present application, and one or more aspects of the present application can also be applied to wireless communication systems that have been commonly used, such as the 4G LTE/LTE-A, or various wireless communication systems to be developed in future. Equivalents to the architecture, entities, functions, processes and the like as described in the following description may be found in these communication systems.

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

Moreover, various embodiments are described with regard to a “base station”. However, reference to a base station is merely provided for illustrative purposes. The term “base station” as used in the present application is an example of a control device in a wireless communication system, with its full breadth of ordinary meaning. For example, in addition to the gNB specified in the 5G NR, the “base station” may also be, for example, a ng-eNB compatible with the NR communication system, an eNB in the LTE communication system, a remote radio head, a wireless access point, a relay node, a drone control tower, or any communication device or an element thereof for performing a similar control function.

### System Overview

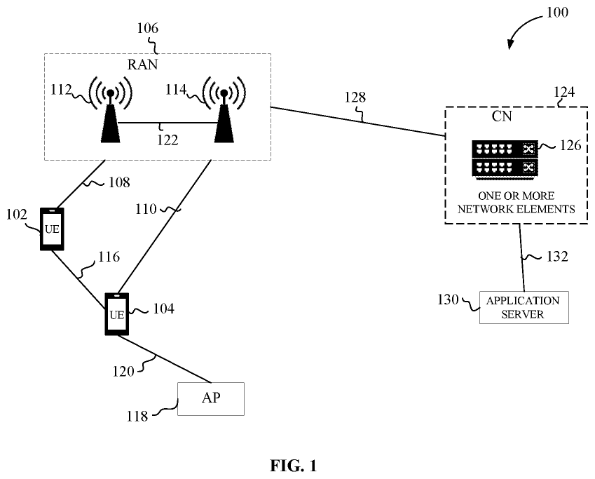

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to the 5GC, between a base station 112 (e.g., a gNB) connecting to 5GC and an eNB, and/or between two eNBs connecting to the 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

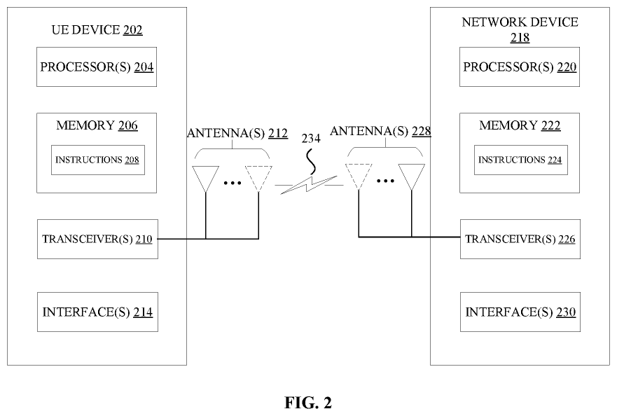

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

A Non-Terrestrial Network (NTN) is a network or segment of network deployed using a communication platform at an altitude of more than tens of kilometers. The platform may be a space-borne vehicle, such as a Low Earth Orbit (LEO) satellite, a Middle Earth Orbit (MEO) satellite, a Geostationary Earth Orbit (GEO) satellite, or a Highly Eccentric Orbit (HEO) satellite, or may be an airborne vehicle such as a Hight Altitude Platform System (HAPS).

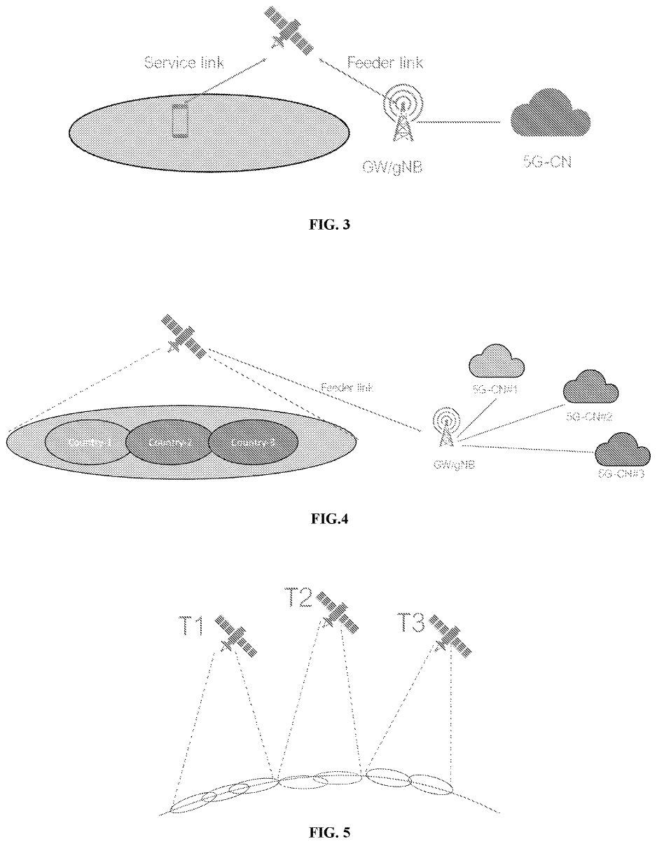

The NTN may enrich usage scenarios of a wireless communication system such as the NR communication system. For example, the NTN may implement ubiquitous coverage in remote rural communities, airplane communications, maritime or railway communications, backhaul, or the like. FIG. 3 shows an example of the NTN architecture in an air-to-ground (ATG) scenario. As shown, a satellite or HAPS serves as a repeater and thus transmits transparent payloads between a UE and a gNB on the ground via a service link with the UE and a feeder link with the gNB. The satellite or HAPS projects one or more beams towards the earth so as to form one or more cells on the earth. For easy illustration, the following descriptions are given by taking the satellite as example of the airborne or spaceborne platform in the NTN, but the present application is not limited thereto.

In the NTN, the coverage of a cell or a beam is typically much larger than that in a Terrestrial Network (TN). For example, the coverage of an NTN cell may be across multiple countries, as illustrated in FIG. 4. The NTN can broadcast a single or multiple Public Land Mobile Networks (PLMNs) and a single or multiple Tracking Area Codes (TACs) per PLMN (up to a total of 12) in one cell. A UE is not expected to perform a registration procedure if one of the currently broadcast TACs belongs to the UE's registration area.

Depending on a type and a beam status of the satellite, the NTN cell may be classified as an earth fixed cell, a quasi-earth fixed cell or an earth moving cell. The earth fixed cell is a stationary region mapped onto the surface of the earth that has permanent fixed boundaries, and is often formed by a GSO. The quasi-earth fixed cell is an NTN cell fixed with respect to a certain geographic area on the earth during a certain time duration, and can be provisioned by beam(s) covering one geographic area for a limited period and a different geographic area during another period (e.g., the case of NGSO satellites generating steerable beams). The earth moving cell is an NTN cell that moves on the earth as the satellite moves.

Cell selection or reselection measurement is defined only for the quasi-earth fixed cell at present. In a location-based measurement for the quasi-earth fixed cell scenario, the UE may compare a distance between the UE and a reference location of its serving cell with a distance threshold, and if the distance threshold is exceeded, the UE shall initiate intra-frequency, inter-frequency or inter-RAT Radio Resource Management (RRM) measurements on cells/frequencies with a priority equal to or lower than that of the serving cell. In a time-based measurement for the quasi-earth fixed cell scenario, the UE receives timing information (i.e., t-Service) from SIB19 which refers to the time on when the serving cell is going to stop serving a geographical area it is currently covering. If t-Service of the serving cell is present in SIB19, the UE shall perform intra-frequency, inter-frequency or inter-RAT measurements with equal or lower priority before t-Service. The exact time to initiate the RRM measurements before t-Service is up to UE implementation.

As used in the present application, the terms “cell selection”, “cell reselection” are UE mobility procedures described for different Radio Resource Control (RRC) states. In the 5G NR, three RRC states are defined, including RRC_IDLE state, RRC_INACTIVE state, and RRC CONNECTED state. Generally speaking, after a UE has switched on and a PLMN has been selected, the cell selection process takes place, and allows the UE in the RRC IDLE state to select a suitable cell where to camp on in order to access available services. In this process, the UE can use stored information (Stored information cell selection) or not (Initial cell selection). The UE may enter the RRC_CONNECTED state by establishing an RRC connection. In addition, the UE in the RRC_CONNECTED state can enter the RRC IDLE or RRC INACTIVE state by releasing the RRC connection. When camped on a cell, the UE in the RRC IDLE or RRC_INACTIVE state shall regularly search for a better cell according to the cell reselection criteria. If a better cell is found, that cell is selected, and this process is called “cell reselection”. The change of cell may imply a change of RAT. Moreover, a process that the UE in the RRC CONNECTED state switches from the current serving cell to a target neighbor cell is called “handover”.

However, in the earth moving cell scenario, since the coverage of the cell is changing due to the satellite's movement, the mobility measurements may face more challenges. FIG. 5 illustrates coverages of a serving cell provided by a satellite and neighbor cells at three time instances (T1, T2, T3). As shown in FIG. 5, on the one hand, the serving cell moves on the earth from the time T1 to the time T3, so that the RRM measurement imitation point based on a fixed reference location or t-service of the serving cell is not as feasible as in the quasi-earth fixed cell scenario. On the other hand, at different time instances, neighbor NTN or TN cells on which the UE shall perform the RRM measurements may also be different.

According to embodiments of the present application, the UE considers the movement of serving cell to determine when to initiate the RRM measurement for intra-frequency, inter-frequency and inter-RAT.

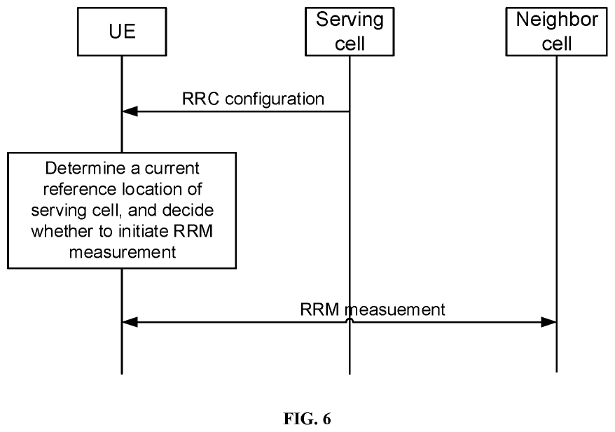

FIG. 6 shows a swimlane diagram of a process of initiating the RRM measurement according to embodiments of the present application. As shown, the process may start from the UE receiving necessary RRC configuration from its serving cell. By means of the RRC configuration, the UE can be provided with at least a reference location and movement information of the serving cell. In addition, the RRC configuration may implicitly or explicitly indicate a type of the serving satellite (i.e., the earth moving cell or quasi-fixed cell) of the serving cell to the UE. According to the present application, the serving cell is an earth moving cell as explained above. Optionally, the RRC configuration may further indicate a beam status (i.e., a fixed beam or a moving beam) for the serving cell.

According to embodiments of the present application, the RRC configuration may include SIB19 which contains satellite assistance information. SIB19 may configure various information including but not limited to:
ntn-config, for providing parameters needed for the UE to access NR via NTN access such as ephemeris information, common TA parameters, k_offset, validity duration for UL sync information and epoch time. Among them, the ephemeris information can provide satellite ephemeris either in format of position and velocity state vector or in format of orbital parameters, and the epoch time indicates the epoch time for assistance information (e.g., the serving satellite ephemeris) and is the starting time of a DL sub-frame, indicated by a System Frame Number (SFN) and a sub-frame number signaled together with the assistance information. Alternatively, the epoch time may be a Universal Time Coordinated (UTC) time;
referenceLocation, indicating a reference location of the serving cell (likely a center of the cell) corresponding to the epoch time. The update on referenceLocation does not necessarily lead to System Information (SI) modification procedure;
distanceThresh, indicating a distance threshold from a reference point of the serving cell;
ntn-NeighCellConifigList, providing a list of NTN neighbor cells including their ntn-Config, carrier frequency and PhysCellId.

Then, as shown in FIG. 6, the UE may determine a reference location corresponding to the current time, called “current reference location”, based on the movement information of the serving cell. Non-limiting examples of the determination of the current reference location are provided here.

As a first example, the UE may determine the current reference location of the serving cell based on the reference location indicated in e.g. SIB19 and a moving speed of the serving satellite:

CurrentreferenceLocation=referenceLocation+Vsatellite*(t−Tephoch) (1)

wherein Vsatellite represents to a moving speed of the serving satellite as an approximation to the moving speed of the serving cell, and may be acquired from the ephemeris information of the serving satellite. referenceLocation represents the reference location corresponding to the epoch time (Tephoch) as indicated in the SIB19, and t represents the current time.

As a second example, considering that the moving speed of the satellite may not be equal to the moving speed of the serving cell, especially when the transmission beam direction of the satellite is not fixed (it is questionable for the fixed beam as well), an adaptation is made to the moving speed of the satellite Vsatellite with a scaling factor α, then the current reference location of the serving cell may be calculated as

CurrentreferenceLocation=referenceLocation+α*Vsatellite*(t−Tephoch) (2)

The scaling factor α may be indicated by the serving cell, for example, via SIB19. Alternatively, the scaling factor α may be derived from the ephemeris information of the serving satellite.

As a third example, instead of the moving speed of the serving satellite, the moving speed of reference point (e.g., the center of the cell) of the serving cell may be indicated to the UE, for example, via SIB19. Then, the current reference location of the serving cell may be calculated as

CurrentreferenceLocation=referenceLocation+Vreferencepoint*(t−Tephoch) (3)

wherein Vreferencepoint represents the moving speed of reference point of the serving cell.

In the above first, second and third example, the moving speed of the satellite or reference point may further include a higher order derivation if the satellite or reference point of the serving cell is not moving linearly. For example, the moving speed may include a first-order derivation (V) and a second-order derivation (D) of the movement of the satellite or the reference point of the serving cell, and the current reference location may be calculated as

CurrentreferenceLocation=referenceLocation+V*(t−Tephoch)+D*(t−Tephoch)*(t−Tephoch) (4)

The UE can derive the satellite type implicitly from the presence or absence of the scaling factor, the moving speed of reference point or the derivations (V, D) of the movement. In a case of the presence of such information, the UE can derive that the cell is an earth moving cell. Otherwise, the UE can derive that the cell is a quasi-earth fixed cell or an earth fixed cell.

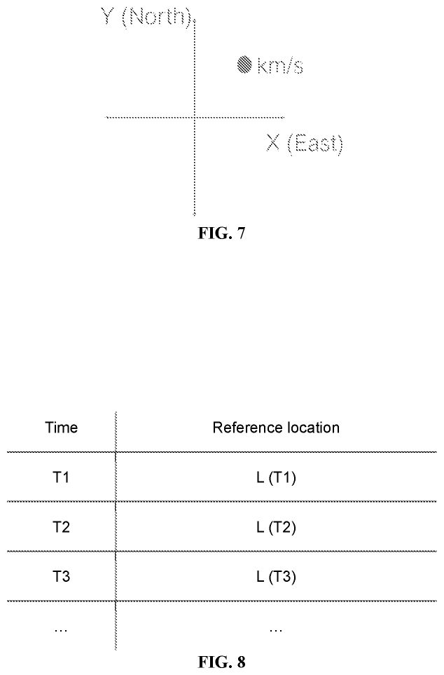

Furthermore, in the above first, second and third example, the location and the moving speed may be expressed in two dimensions and thus the determination may be performed in the two dimensions. FIG. 7 shows an example of decomposition of the serving cell's movement, by taking the east direction (X) and the north direction (Y) as example dimensions. In this instance, the current reference location may be determined by calculating equations (1), (2), (3) or (4) in each of the X and Y dimensions.

As a fourth example, a table of [time, reference location] list may be indicated to the UE via the RRC configuration, for example, via SIB19. FIG. 8 illustrates such a table, which includes a list of times and a corresponding list of reference locations. The table can be considered as including the movement information of the serving cell in form of a discrete trajectory. The UE can calculate the current reference location by using linear interpolation based on the current time. Assuming that the current time Tx is between T1 and T2, then the current reference location can be calculated as

CurrentreferenceLocation=L(T1)+(Tx−T1)/(T2−T1)*(L(T2)−L(T1)) (5)

Then, the UE may decide whether to initiate RRM measurement on at least one neighbor cell based on the determined current reference location. For example, the UE may compare a distance between the UE's location (e.g., acquired from Global Navigation Satellite System (GNSS)) and the current reference location of the serving cell with a distance threshold indicated in the RRC configuration (e.g., SIB19). If the distance threshold is exceeded, then the UE may decide to initiate the RRM measurement for the cell reselection or handover purpose, for example, the UE may measure received power (RSRP), received quality (RSRQ) and/or Signal to Interference plus Noise Ratio (SINR) of a reference signal from the neighbor cell. Otherwise, the UE may decide not to initiate the RRM measurement, since the UE does not reach an edge of the serving cell.

The UE in the RRC_IDLE or RRC_INACTIVE state may perform the RRM measurement on a configured set of neighbor cells to reselect a better cell to camp on. The configured neighbor cells may be NTN cells. In the earth moving cell scenario, neighbor cells are changing constantly because the speed/orbit of satellites (including earth moving satellites, earth fixed satellites and quasi-earth fixed satellites) may be different compared to the serving satellite. For the UE, it is not power friendly to perform the RRM measurement on some NTN neighbor cells far away.

According to embodiments of the present application, the UE may filtrate the configured NTN neighbor cells and perform the RRM measurement on only those in its vicinity at the current time.

In some embodiments, the UE may receive, e.g., via SIB19, a neighbor cell configuration which includes one or more sets of NTN neighbor cells each corresponding to a different application time. FIG. 9 illustrates an example of the neighbor cell configuration in which Neighbor cell set 1 corresponding to Application time T0, Neighbor cell set 2 corresponding to Application time T1, and the like are included.

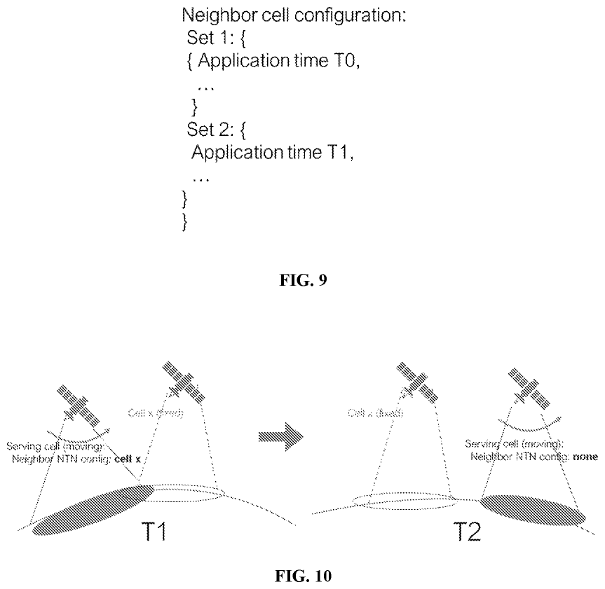

When the UE needs to perform the RRM measurement (for example, through the decision in FIG. 6), the UE may select, from the neighbor cell configuration, a set of NTN neighbor cells to be measured which corresponds to an application time nearest to the current time. For example, as shown in FIG. 10, at the time T1, an NTN cell x (shown as an earth fixed cell without limitation) is in the vicinity of the serving cell, and it is configured to the UE in correspondence to the time T1; then at the time T2, the cell x is far away from the serving cell and is not included in the configured neighbor cell set corresponding to T2, and the UE may not perform the RRM measurement on it.

Alternatively, the UE may select the NTN neighbor cells to be measured based on location. Specifically, the UE may receive a reference location and movement information for each of a configured set of NTN neighbor cells via RRC configuration (e.g., SIB19), and determine a current reference location of the NTN neighbor cell.

The determination of the current reference location of the NTN neighbor cell may be the same as that of the serving cell. As an example, the current reference location of the neighbor cell can be calculated based on the reference location as configured and a moving speed of the neighbor satellite, according to the above equations (1), (2) or (4). As another example, the current reference location of the neighbor cell can be calculated based on the reference location as configured and a moving speed of reference point of the neighbor satellite, according to the above equations (3) or (4). As yet another example, the current reference location of the neighbor cell can be calculated based on the [time, reference location] list of the neighbor cell by using linear interpolation, according to the above equations (5). Details are not repeated here.

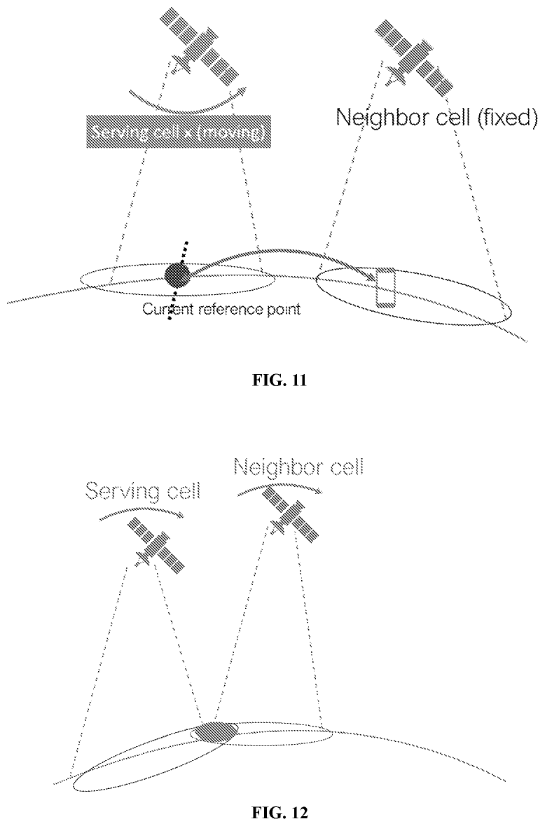

The UE then can compare a distance between the current reference location of the serving cell and the current reference location of each of the NTN neighbor cells with a distance threshold (e.g., configured via SIB19), as shown in FIG. 11. If the distance between the current reference location of the serving cell and the current reference location of the neighbor cell is larger than the distance threshold, the UE may perform the RRM measurement on this NTN neighbor cell, for example, for the cell reselection purpose. Otherwise, the UE would not perform the RRM measurement since it is far away.

Optionally, a hysteresis may be considered in the comparison with the distance threshold. The hysteresis can be indicated to the UE via RRC configuration, for example, via SIB19, and is used to modify the distance threshold. In this instance, the UE may compare the distance between the current reference location of the serving cell and the current reference location of each of the neighbor cells with a distance threshold plus a hysteresis, if the neighbor satellite is approaching to the UE according to its ephemeris, or the UE may compare the distance between the current reference location of the serving cell and the current reference location of each of the neighbor cells with a distance threshold minus a hysteresis, if the neighbor satellite is moving away from the UE. The UE may decide whether to perform the RRM measurement on the NTN neighbor cell based on the comparison.

The UE may be configured with TN neighbor cells or frequencies for the cell reselection purpose. The TN cells may be likely configured with higher priority than the NTN cells, so that UE power consumption gets increased significantly due to two reasons: 1) the actual neighbor cell/frequency set of TN cells are constantly changing due to the movement of serving cell but SIB may not update that frequently; 2) in many geographical positions inside one NTN cell, there might be no neighbor TN cells because the NTN cell may cover hundreds of km(s).

According to embodiments of the present application, the UE may filtrate the configured TN neighbor cells and perform the RRM measurement on only those in its vicinity at the current time, in a similar way to the above case of NTN neighbor cells.

In some embodiments, the UE may receive, e.g., via SIB19, a neighbor cell configuration which includes one or more sets of TN neighbor cells each corresponding to a different application time. When the UE needs to perform the RRM measurement (for example, through the decision in FIG. 6), the UE may select, from the neighbor cell configuration, a set of TN neighbor cells to be measured which corresponds to an application time nearest to the current time.

Optionally, the TN neighbor cells may be configured with a finer geographical granularity than the cell level. For example, the neighbor cell configuration may include beam-level TN neighbor cells/frequencies corresponding to different application times; or geographical position-based TN neighbor cells/frequencies corresponding to different application times; or zone (like in V2X) based TN neighbor cells/frequencies corresponding to different application times.

Alternatively, the UE may select the TN neighbor cells to be measured based on location. Specifically, the UE may receive a reference location for each of a configured set of TN neighbor cells via RRC configuration (e.g., SIB19).

The UE then can compare a distance between the current reference location of the serving cell and the current reference location (i.e., the reference location as configured since it is fixed) of each of the TN neighbor cells with a distance threshold (e.g., configured via SIB19). If the distance between the current reference location of the serving cell and the reference location of the neighbor cell is larger than the distance threshold, the UE may perform the RRM measurement on this TN neighbor cell. Otherwise, the UE would not perform the RRM measurement.

The above discussions mainly focus on the RRM measurement by the UE in the RRC_IDLE or RRC_INACTIVE state, but some embodiments of the present application may be applicable to the RRM measurement in the RRC_CONNECTED state.

In current mechanism on the connected-state RRM measurement, the UE is required to perform the RRM measurement on all measurement objects (MOs) configured by the network, for example, via Information Element (IE) MeasObject. However, the MO(s) configured by the network may become obsolete due to serving or neighbor cells' movement. If relying on the network to update the MO(s) configuration timely based on the serving and neighbor cells' movement, it may lead to a lot of RRC signaling since the NTN cell supports many UE(s) in the cell.

According to some embodiments of the present application, the UE can perform the RRM measurement on only the MO(s) which have cells nearby. Specifically, the UE may determine a current reference location of each neighbor cell (NTN cell or TN cell) by using the determination methods as described above.

For an NTN neighbor cell in the MO, the UE may determine its current reference location based on the moving speed of the satellite, the moving speed of reference point (e.g., a center) of the cell, or a list of reference locations corresponding to different times. The UE may then compare a distance between the UE's location and the current reference location of the NTN neighbor cell with a distance threshold (e.g., configured via SIB19). If the distance threshold is exceeded for at least one of the NTN neighbor cells in the MO, the UE may perform the RRM measurement on that MO.

Similarly, for a TN neighbor cell in the MO, the UE may determine its current reference location as the reference location configured via, for example, SIB19. The UE may then compare a distance between the UE's location and the reference location of the TN neighbor cell with a distance threshold (e.g., configured via SIB19). If the distance threshold is exceeded for at least one of the TN neighbor cells in the MO, the UE may perform the RRM measurement on that MO.

In the instance of the connected-state RRM measurement, the satellite assistance information may be indicated via the RRC configurations of the serving cell or neighbor cell in SIB19, including but not limited to the ephemeris information, the reference location, the distance threshold, the moving speed of the satellite or the reference point and optionally the scaling factor for adapting the moving speed. Alternatively, the RRM imitation condition, such as the distance threshold between the UE and neighbor cells in the MO, may be configured to the UE in the IE MeasObject. The condition may be specific to cells, for example, if any cell in cellsToAddModList or allowedCellsToAddModList satisfies the condition, the UE may perform the RRM measurement on the entire list. Alternatively, the condition may be specific to a frequency, that is, if any cell on that frequency satisfies the condition, the UE may initiate the RRM measurement on that freq.

The UE in the RRC_CONNECTED state may execute conditional handover (CHO) by itself if predefined conditions are met. However, since the coverage of the serving cell and/or neighbor cell is changing, the CHO execution location is also changing. FIG. 12 illustrates an example scenario for the CHO, in which the neighbor cell is shown as an NTN cell, but it is not limited thereto. The UE at the edge of the serving cell may decide whether to perform the CHO based on location.

Specifically, the UE may determine the current reference location of the serving cell. The UE also determines the current reference location of the neighbor cell. For a TN neighbor cell or an earth fixed neighbor cell, its reference location is fixed, for a quasi-earth fixed neighbor cell, its current reference location is that configured by SIB19, and for an earth moving neighbor cell, its current reference location can be determined by using the above determination method.

Then, the UE may test the following conditions:

A distance between the UE location and the current reference location of the serving cell is equal to or larger than a first distance threshold; and
A distance between the UE location and the current reference location of the neighbor cell is equal to or smaller than a second distance threshold.

If both of the two conditions are satisfied, the UE may perform the CHO process. Otherwise, the UE may not perform the CHO process.

Embodiments contemplated herein include an apparatus comprising means to perform one or more elements of the method as above. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method as above. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method as above. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method as above. This apparatus may be, for example, an apparatus of a UE (such as a wireless device 202 that is a UE, as described herein).

Embodiments contemplated herein include a signal as described in or related to one or more elements of the method as above.

Embodiments contemplated herein include a computer program or computer program product comprising instructions, wherein execution of the program by a processor is to cause the processor to carry out one or more elements of the method as above. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method as above. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method as above. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method as above. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method as above. This apparatus may be, for example, an apparatus of a base station (such as a network device 218 that is a base station, as described herein).

Embodiments contemplated herein include a signal as described in or related to one or more elements of the method as above.

Embodiments contemplated herein include a computer program or computer program product comprising instructions, wherein execution of the program by a processing element is to cause the processing element to carry out one or more elements of the method as above. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

### EXAMPLE SECTION

The following examples pertain to further embodiments.

Example 1 may include an apparatus of a user equipment (UE), the apparatus comprising a processor, and a memory storing instructions that, when executed by the processor, configure the apparatus to: receive a reference location and movement information of a serving cell of the UE which is an earth moving cell; determine a current reference location of the serving cell based on the received reference location and movement information; and decide whether to initiate Radio Resource Management (RRM) measurement on neighbor cells based on the current reference location of the serving cell.

Example 2 may include the apparatus of Example 1, wherein the movement information of the serving cell includes a moving speed of a satellite forming the serving cell, and wherein the current reference location is determined based on the reference location and the moving speed of the satellite.

Example 3 may include the apparatus of Example 2, wherein the moving speed of the satellite is derived by the UE from ephemeris information of the satellite.

Example 4 may include the apparatus of Example 2, wherein the movement information of the serving cell further includes a scaling factor for adapting the moving speed of the satellite, and wherein the current reference location is determined based on the reference location and the adapted moving speed of the satellite.

Example 5 may include the apparatus of Example 1, wherein the movement information of the serving cell includes a moving speed of reference point of the serving cell, and wherein the current reference location is determined based on the reference location and the moving speed of reference point of the serving cell.

Example 6 may include the apparatus of Example 1, wherein the movement information of the serving cell includes a list of reference locations of the serving cell corresponding to different times, and wherein the current reference location is determined based on the list of reference locations and a current time.

Example 7 may include the apparatus of Example 1, wherein the instructions that, when executed by the processor, further configure the apparatus to: compare a distance between a location of the UE and the current reference location of the serving cell with a threshold; and decide to initiate the RRM measurement on at least one neighbor cell if the distance between the location of the UE and the current reference location of the serving cell is larger than the threshold.

Example 8 may include the apparatus of Example 7, wherein the instructions that, when executed by the processor, further configure the apparatus to: receive a neighbor cell configuration which indicates one or more sets of neighbor cells, each set of neighbor cells corresponding to a respective application time, and include one set of neighbor cells, which corresponds to an application time nearest to a current time, of the one or more sets of neighbor cells, in the at least one neighbor cell to be measured.

Example 9 may include the apparatus of Example 8, wherein the one or more sets of neighbor cells include any of beam-level Terrestrial Network (TN) cells, geographical position-based TN cells, zone-based TN cells.

Example 10 may include the apparatus of Example 7, wherein the instructions that, when executed by the processor, further configure the apparatus to: for each neighbor cell of a set of neighbor cells, compare a distance between the location of the UE and a current reference location of the neighbor cell with a threshold; and include the neighbor cell in the at least one neighbor cell to be measured if the distance between the location of the UE and the current reference location of the neighbor cell is larger than the threshold.

Example 11 may include the apparatus of Example 10, wherein the set of neighbor cells include Non-Terrestrial Network (NTN) neighbor cells, and wherein the instructions that, when executed by the processor, further configure the apparatus to: for each of the NTN neighbor cells, receive a reference location and movement information of the NTN neighbor cell; and determine the current reference location of the NTN neighbor cell based on the reference location and the movement information.

Example 12 may include the apparatus of Example 11, wherein for each of the NTN neighbor cells, the movement information includes one or more of: ephemeris information of a satellite forming the NTN neighbor cell; a scaling factor for adapting the moving speed of the satellite; a moving speed of reference point of the NTN neighbor cell; or a list of reference locations of the NTN neighbor cell corresponding to different times.

Example 13 may include the apparatus of Example 10, wherein the set of neighbor cells include Terrestrial Network (TN) neighbor cells, and wherein the instructions that, when executed by the processor, further configure the apparatus to: for each of the TN neighbor cells, receive a reference location of the TN neighbor cell as the current reference location of the TN neighbor cell.

Example 14 may include the apparatus of Example 1, wherein the at least one neighbor cell to be measured is included in a measurement object (MO), and wherein the instructions that, when executed by the processor, further configure the apparatus to: compare a distance between a location of the UE and a current reference location of each of the neighbor cells with a threshold; and initiate the RRM measurement on the MO if the comparison indicates that the distance between a location of the UE and the current reference location of any neighbor cell is equal to or smaller than the threshold.

Example 15 may include the apparatus of Example 1, wherein the instructions that, when executed by the processor, further configure the apparatus to: compare a distance between a location of the UE and a current reference location of the serving cell with a first threshold; compare a distance between a location of the UE and a current reference location of each of a set of neighbor cells with a second threshold; and decide whether to perform conditional handover (CHO) based on the comparisons.

Example 16 may include an apparatus of a base station, the apparatus comprising: a processor; and a memory storing instructions that, when executed by the processor, configure the apparatus to: send a reference location and movement information of a serving cell of the UE which is an earth moving cell to a user equipment (UE), for the UE to determine a current reference location of the serving cell and to decide whether to initiate Radio Resource Management (RRM) measurement on neighbor cells based on the current reference location of the serving cell.

Example 17 may include the apparatus of Example 16, wherein the movement information of the serving cell includes a moving speed of a satellite forming the serving cell, and wherein the current reference location is determined based on the reference location and the moving speed of the satellite.

Example 18 may include the apparatus of Example 17, wherein the movement information is included in ephemeris information of the satellite.

Example 19 may include the apparatus of Example 16, wherein the movement information of the serving cell further includes a scaling factor for adapting the moving speed of the satellite, and wherein the current reference location is determined based on the reference location and the adapted moving speed of the satellite.

Example 20 may include the apparatus of Example 16, wherein the movement information of the serving cell includes a moving speed of reference point of the serving cell, and wherein the current reference location is determined based on the reference location and the moving speed of reference point of the serving cell.

Example 21 may include the apparatus of Example 16, wherein the movement information of the serving cell includes a list of reference locations of the serving cell corresponding to different times, and wherein the current reference location is determined based on the list of reference locations and a current time.

Example 22 may include the apparatus of Example 16, wherein the instructions that, when executed by the processor, further configure the apparatus to: send a neighbor cell configuration which indicates one or more sets of neighbor cells to the UE, each set of neighbor cells corresponding to a respective application time.

Example 23 may include the apparatus of Example 16, wherein the instructions that, when executed by the processor, further configure the apparatus to: send reference locations of a set of Terrestrial Network (TN) neighbor cells to the UE.

Example 24 may include the apparatus of Example 16, wherein the instructions that, when executed by the processor, further configure the apparatus to: send reference locations and movement information of a set of Non-Terrestrial Network (NTN) neighbor cells to the UE.

Example 25 may include the apparatus of Example 24, wherein for each of the NTN neighbor cells, the movement information includes one or more of: ephemeris information of a satellite forming the NTN neighbor cell; a scaling factor for adapting the moving speed of the satellite; a moving speed of reference point of the NTN neighbor cell; or a list of reference locations of the NTN neighbor cell corresponding to different times.

Example 26 may include a method, the method comprising: receiving a reference location and movement information of a serving cell of the UE which is an earth moving cell; determining a current reference location of the serving cell based on the received reference location and movement information; and deciding whether to initiate Radio Resource Management (RRM) measurement on neighbor cells based on the current reference location of the serving cell.

Example 27 may include a method, the method comprising: sending a reference location and movement information of a serving cell of the UE which is an earth moving cell to a user equipment (UE), for the UE to determine a current reference location of the serving cell and to decide whether to initiate Radio Resource Management (RRM) measurement on neighbor cells based on the current reference location of the serving cell.

Example 28 may include a non-transitory computer readable storage medium containing instructions which, when executed, cause performance of the method of Example 26 or 27.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus of a user equipment (UE), the apparatus comprising:
a processor; and
a memory storing instructions that, when executed by the processor, configure the apparatus to:
receive a reference location and movement information of a serving cell of the UE which is an earth moving cell;
determine a current reference location of the serving cell based on the received reference location and movement information; and
decide whether to initiate Radio Resource Management (RRM) measurement on neighbor cells based on the current reference location of the serving cell.

2. The apparatus of claim 1, wherein the movement information of the serving cell includes a moving speed of a satellite forming the serving cell, and
wherein the current reference location is determined based on the reference location and the moving speed of the satellite.

3. The apparatus of claim 2, wherein the moving speed of the satellite is derived by the UE from ephemeris information of the satellite.

4. The apparatus of claim 2, wherein the movement information of the serving cell further includes a scaling factor for adapting the moving speed of the satellite, and
wherein the current reference location is determined based on the reference location and the adapted moving speed of the satellite.

5. The apparatus of claim 1, wherein the movement information of the serving cell includes a moving speed of reference point of the serving cell, and
wherein the current reference location is determined based on the reference location and the moving speed of reference point of the serving cell.

6. The apparatus of claim 1, wherein the movement information of the serving cell includes a list of reference locations of the serving cell corresponding to different times, and
wherein the current reference location is determined based on the list of reference locations and a current time.

7. The apparatus of claim 1, wherein the instructions that, when executed by the processor, further configure the apparatus to:
compare a distance between a location of the UE and the current reference location of the serving cell with a threshold; and
decide to initiate the RRM measurement on at least one neighbor cell if the distance between the location of the UE and the current reference location of the serving cell is larger than the threshold.

8. The apparatus of claim 7, wherein the instructions that, when executed by the processor, further configure the apparatus to:
receive a neighbor cell configuration which indicates one or more sets of neighbor cells, each set of neighbor cells corresponding to a respective application time, and
include one set of neighbor cells, which corresponds to an application time nearest to a current time, of the one or more sets of neighbor cells, in the at least one neighbor cell to be measured.

9. The apparatus of claim 8, wherein the one or more sets of neighbor cells include any of beam-level Terrestrial Network (TN) cells, geographical position-based TN cells, zone-based TN cells.

10. The apparatus of claim 7, wherein the instructions that, when executed by the processor, further configure the apparatus to:
for each neighbor cell of a set of neighbor cells,
compare a distance between the location of the UE and a current reference location of the neighbor cell with a threshold; and
include the neighbor cell in the at least one neighbor cell to be measured if the distance between the location of the UE and the current reference location of the neighbor cell is larger than the threshold.

11. The apparatus of claim 10, wherein the set of neighbor cells include Non-Terrestrial Network (NTN) neighbor cells, and wherein the instructions that, when executed by the processor, further configure the apparatus to:
for each of the NTN neighbor cells,
receive a reference location and movement information of the NTN neighbor cell; and
determine the current reference location of the NTN neighbor cell based on the reference location and the movement information.

12. The apparatus of claim 11, wherein for each of the NTN neighbor cells, the movement information includes one or more of:
ephemeris information of a satellite forming the NTN neighbor cell;
a scaling factor for adapting the moving speed of the satellite;
a moving speed of reference point of the NTN neighbor cell; or
a list of reference locations of the NTN neighbor cell corresponding to different times.

13. The apparatus of claim 10, wherein the set of neighbor cells include Terrestrial Network (TN) neighbor cells, and wherein the instructions that, when executed by the processor, further configure the apparatus to:
for each of the TN neighbor cells,
receive a reference location of the TN neighbor cell as the current reference location of the TN neighbor cell.

14. The apparatus of claim 1, wherein the at least one neighbor cell to be measured is included in a measurement object (MO), and wherein the instructions that, when executed by the processor, further configure the apparatus to:
compare a distance between a location of the UE and a current reference location of each of the neighbor cells with a threshold; and
initiate the RRM measurement on the MO if the comparison indicates that the distance between a location of the UE and the current reference location of any neighbor cell is equal to or smaller than the threshold.

15. The apparatus of claim 1, wherein the instructions that, when executed by the processor, further configure the apparatus to:
compare a distance between a location of the UE and a current reference location of the serving cell with a first threshold;
compare a distance between a location of the UE and a current reference location of each of a set of neighbor cells with a second threshold; and
decide whether to perform conditional handover (CHO) based on the comparisons.

16. An apparatus of a base station, the apparatus comprising:
a processor; and
a memory storing instructions that, when executed by the processor, configure the apparatus to:
send a reference location and movement information of a serving cell of the UE which is an earth moving cell to a user equipment (UE), for the UE to determine a current reference location of the serving cell and to decide whether to initiate Radio Resource Management (RRM) measurement on neighbor cells based on the current reference location of the serving cell.

17. The apparatus of claim 16, wherein the movement information of the serving cell includes a moving speed of a satellite forming the serving cell, and
wherein the current reference location is determined based on the reference location and the moving speed of the satellite.

18. The apparatus of claim 17, wherein the movement information is included in ephemeris information of the satellite.

19. The apparatus of claim 16, wherein the movement information of the serving cell further includes a scaling factor for adapting the moving speed of the satellite, and
wherein the current reference location is determined based on the reference location and the adapted moving speed of the satellite.

20. The apparatus of claim 16, wherein the movement information of the serving cell includes a moving speed of reference point of the serving cell, and
wherein the current reference location is determined based on the reference location and the moving speed of reference point of the serving cell.

21-28. (canceled)
